(19) United States
(12) Patent Application Publication
(10) Pub. No.: US 2013/0039312 A1
(43) Pub. Date: Feb. 14, 2013

(54) TRANSMITTING PARTICULAR CONTROL INFORMATION ON AN UPLINK TRAFFIC CHANNEL ON A REPEATED BASIS

(71) Applicants: Lai King TEE, San Diego, CA (US); Jun LI, Ricardson, TX (US)

(72) Inventors: Lai King TEE, San Diego, CA (US); Jun LI, Ricardson, TX (US)

(73) Assignee: RESEARCH IN MOTION LIMITED, Waterloo (CA)

(21) Appl. No.: 13/620,450

(22) Filed: Sep. 14, 2012

Related U.S. Application Data
(63) Continuation of application No. 13/264,314, filed on Oct. 13, 2011.
(60) Provisional application No. 61/169,138, filed on Apr. 14, 2009.

(51) Int. Cl. H04W 72/04

(52) U.S. Cl. 370/329

(57) ABSTRACT

In a communications system, a mobile station receives, from a base station, a downlink control message associated with an indication that particular control information is to be transmitted by the mobile station on an uplink traffic channel on a repeated basis. In response to receiving the downlink control message associated with the indication, the particular control information is transmitted on the uplink traffic channel to a base station on a repeated basis.

### CROSS-REFERENCE TO RELATED APPLICATIONS

This application is a continuation of U.S. application Ser. No. 13/264,314, filed Oct. 13, 2011, which is a U.S. National Stage Patent Application of International Application No. PCT/US2010/031018, filed Apr. 14, 2010, which claims priority to U.S. Provisional Application No. 61/169,138, filed Apr. 14, 2009, all of which are incorporated herein by reference in their entireties.

### BACKGROUND

Various wireless access technologies have been proposed or implemented to enable mobile stations to perform communications with other mobile stations or with wired terminals coupled to wired networks. Examples of wireless access technologies include GSM (Global System for Mobile communications) and UMTS (Universal Mobile Telecommunications System) technologies, defined by the Third Generation Partnership Project (3GPP); and CDMA 2000 (Code Division Multiple Access 2000) technologies, defined by 3GPP2. CDMA 2000 defines one type of packet-switched wireless access network, referred to as the HRPD (High Rate Packet Data) wireless access network.

Another more recent standard that provides packet-switched wireless access networks is the Long Term Evolution (LTE) standard from 3GPP, which seeks to enhance the UMTS technology. The LTE standard is also referred to as the EUTRA (Evolved Universal Terrestrial Radio Access) standard.

### SUMMARY

In general, according to some embodiments, a mobile station receives a downlink control message associated with an indication that particular control information is to be transmitted by the mobile station on an uplink traffic channel on a repeated basis.

Other or alternative features will become apparent from the following description, from the drawings, and from the claims.

### BRIEF DESCRIPTION OF THE DRAWINGS

Some embodiments are described with respect to the following figures:

FIG. 1 is a block diagram of an example communications network that incorporates some embodiments of the invention; and

FIG. 2 is a flow diagram of a process of performing semi-persistent scheduling for transmission of particular control information, according to some embodiments.

### DETAILED DESCRIPTION

In wireless communications networks, control channels are defined for both the uplink direction and the downlink direction for communicating respective uplink control information and downlink control information. For example, in an EUTRA (Evolved Universal Terrestrial Radio Access) network, according to the EUTRA standards from 3GPP (Third Generation Partnership Project), an uplink control channel for communicating uplink control information is the physical uplink control channel (PUCCH), and a downlink control channel for communicating downlink control information is the physical downlink control channel (PDCCH). The EUTRA standard is also referred to as the Long Term Evolution (LTE) standard.

Although reference is made to the EUTRA standard in some implementations, note that techniques according to some embodiments can also be applied to other types of wireless communications networks. Note that EUTRA can refer to the current standard, or to modifications of the EUTRA standard that are made over time. It is expected that in the future a standard that has evolved from EUTRA may be referred to by another name, and therefore, reference to “EUTRA” herein is intended to cover such future standards as well.

As noted above, in an EUTRA wireless communications network, the PUCCH is generally used to transmit uplink control information from a mobile station to a base station. However, there can be various drawbacks in the use of PUCCH for communicating uplink control information. In one example, out-of-band radio frequency (RF) emission from PUCCH signaling may cause interference with other devices, such as devices in an adjacent public safety RF band. Moreover, PUCCH can limit reporting of certain types of control information, which may not allow for optimal performance in the EUTRA wireless communications network. For example, one type of uplink control information that is reported from the mobile station to a base station is a PMI (precoding matrix indicator). PMI refers to an index (or other type of indicator) to enable selection of a precoding vector to be applied to wireless transmissions. Different values of PMI select different codewords for performing the desired precoding. In certain modes, such as a closed-loop MIMO (multiple input, multiple output) mode, it may be desired to provide feedback of more than one PMI in each report sent on the PUCCH. For example, it may be desired to provide multiple PMIs and/or CQIs (channel quality indicators) for respective sub-bands (of different frequency ranges). However, since PUCCH limits the feedback to just one PMI, it would not be possible to use PUCCH to report multiple PMIs for multiple sub-bands in closed loop MIMO mode. Besides, the amount of channel resources available for PUCCH is more limited with a somewhat fixed coding rate, thus PUCCH is not so flexible.

In accordance with some preferred embodiments, to support more robust communication of certain uplink control information (referred to herein as “particular uplink control information”), an uplink traffic channel can be used, either instead of or in addition to the PUCCH, for communicating the particular control information, including PMI. In the EUTRA context, an uplink traffic channel is the physical uplink shared channel (PUSCH). The use of PUSCH would allow for more flexible and robust communication of the particular uplink control information from the mobile station to the base station.

In addition to PMI, the particular uplink control information that can be sent by the mobile station over the PUSCH can further include one or more of the following: a channel quality indicator (CQI), a rank indicator (RI), a hybrid automatic repeat request acknowledgment (HARQ-ACK), or other uplink control information.

CQI is an indication of wireless channel quality between the base station and the mobile station. HARQ is used to perform error control in wireless communications. The rank indicator (RI) is used to indicate the particular rank to be used. For example, rank 1 refers to use of just a single layer for a wireless channel that communicates data between a base station and a mobile station. With such single-layer communications, the same signal is emitted from each of the transmit antennas (such that redundancy is provided) over multiple paths. Rank 2 indicates that a particular wireless channel used to communicate data between the base station and the mobile station is able to use two layers that employ multiple spatial beams along multiple paths in a cell. With rank 2 communications, independent data can be sent over 2 layers to increase throughput between the mobile station and base station. Other ranks are also possible.

In some embodiments, for enhanced efficiency, particular control information is transmitted repeatedly (e.g., periodically) on the PUSCH using semi-persistent scheduling (SPS). Semi-persistent scheduling refers to a persistent scheduling for transmission of certain information on a wireless control channel, on a repeated (e.g., periodic) basis, using the same transport block size, modulation and coding scheme and channel resources until changed. By using semi-persistent scheduling to allow for repeated (e.g., periodic) transmission of particular uplink control information over the PUSCH, efficiency is enhanced since a specific grant does not have to be transmitted from the base station to the mobile station each time particular uplink control information has to be sent from the mobile station to the base station. Having to send multiple grants to perform multiple transmissions of the particular uplink control information can be inefficient in that the grants (and requests associated with such grants) take up valuable bandwidth of the wireless link between the mobile station and the base station. By using semi-persistent scheduling, the mobile station is able to transmit the particular uplink control information on a repeated basis (e.g., periodic basis) on scheduled resources (e.g., scheduled sub-frames) until the base station sends further signaling to cause the semi-persistent scheduling to change.

Although reference is made to specific control channels, such as PUCCH, PUSCH, and PDCCH in this discussion, it is noted that in different implementations, other types of control channels can be employed.

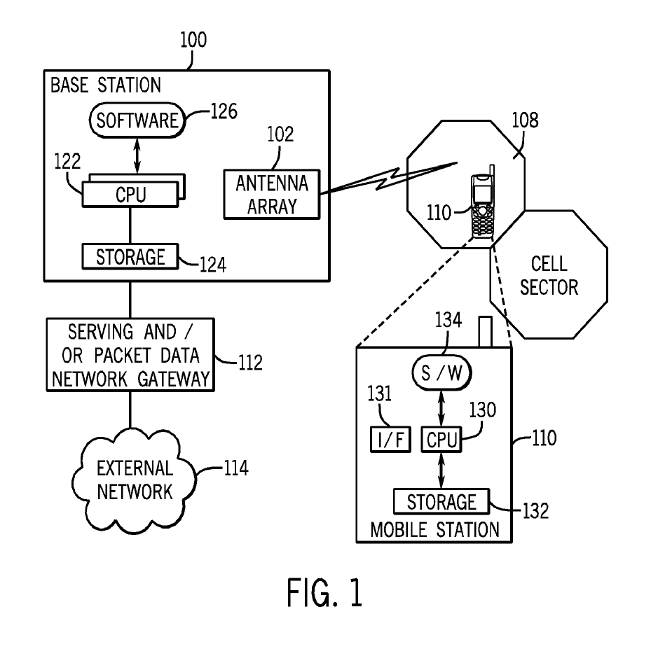

FIG. 1 shows an example wireless communications network in which some embodiments of the invention can be incorporated. The wireless communications network includes a base station 100 that includes an antenna array or other antenna assembly 102 for sending wireless signals into a cell sector 108. A cell sector is one section of a cell of a cellular network. In alternative implementations, element 108 can represent an entire cell.

Although just one base station 100 is depicted in FIG. 1, it is noted that a wireless communications network would typically include multiple base stations. In some embodiments, the wireless communications network is an EUTRA wireless communications network.

In an EUTRA wireless communications network, the base station 100 is an enhanced node B (“eNode B”), which includes a base transceiver station that includes the antenna array 102. The base station 100 may also include a radio network controller that cooperates with the enhanced node B. The radio network controller and/or enhanced node B can perform one or more of the following tasks: radio resource management, mobility management for managing mobility of mobile stations, routing of traffic, and so forth. Note that one radio network controller can access multiple eNode Bs, or alternatively, an eNode B can be accessed by more than one radio access controller.

More generally, the term “base station” can refer to a cellular network base station, an access point used in any type of wireless network, or any type of wireless transmitter to communicate with mobile stations. The term “base station” can also encompass an associated controller, such as a base station controller or a radio network controller. It is also contemplated that the term “base station” also refers to a femto base station or access point, a micro base station or access point, or a pico base station or access point. A “mobile station” can refer to a telephone handset, a portable computer/device, a personal digital assistant (PDA), or an embedded device such as a health monitor, attack alarm, and so forth.

As depicted in FIG. 1, the base station 100 includes one or more central processing units (CPUs) 122, which is (are) connected to storage 124. Moreover, the base station 100 includes software 126 that is executable on the CPU(s) 122 to perform tasks of the base station 100.

The mobile station 110 of FIG. 1 also includes one or more CPUs 130 that are connected to storage 132. The mobile station 110 also includes software 134 that is executable on the CPU(s) 130 to perform tasks of the mobile station 110. In addition, the mobile station 110 includes an interface 131 to communicate wirelessly with the base station 100.

The base station 100 is connected to a serving and/or packet data network (PDN) gateway 112, which terminates the user plane interface toward the enhanced node B and assumes the responsibility for packet routing and transfer towards an external network 114, which can be a packet data network such as the Internet or other type of network.

The arrangement depicted in FIG. 1 is provided for purposes of example. In other implementations, other wireless network arrangements are used.

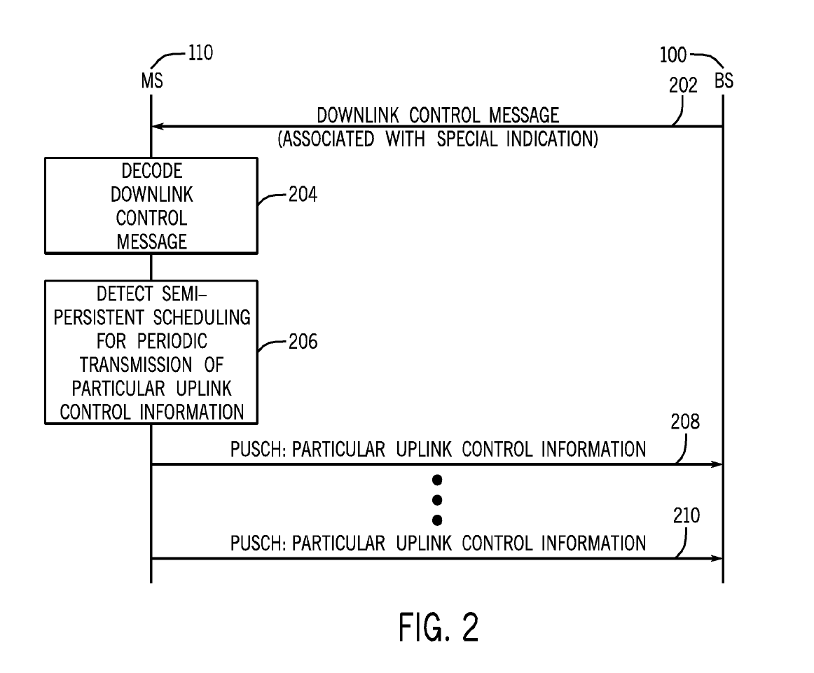

FIG. 2 is a flow diagram depicting message exchanges between the mobile station 110 and base station 100. To set up a semi-persistent scheduling for repeated (e.g., periodic) transmission of particular uplink control information, the base station 100 sends a downlink control message (at 202), where the downlink control message is associated with a special indication. The downlink control message in some implementations includes downlink control information (DCI) according to the EUTRA standard.

The special indication that is associated with the downlink control message is a semi-persistent scheduling RNTI (radio network temporary identifier) (SPS-RNTI). The SPS-RNTI can be used to scramble a portion of the DCI, such as the cyclic redundancy check (CRC) portion of the DCI. The CRC is computed based on content of the DCI, and is used for error detection. In alternative implementations, the portion of the downlink control message that is scrambled with the special indication is the entirety of the downlink control message.

The downlink control message can be transmitted on the PDCCH from the base station 100 to the mobile station 110. In alternative implementations, the downlink control message can be sent on a different downlink channel. In addition to sending the downlink control message, an RRC (radio resource control) reconfiguration message is also sent from the base station 100 to the mobile station 110 to indicate the periodicity of the semi-persistent scheduling.

Upon receiving the downlink control message associated with the special indication, the mobile station 110 decodes (at 204) the downlink control message. If the downlink control message is associated with the special indication, then the decoding of a downlink control message would allow the mobile station 110 to detect (at 206) that semi-persistent scheduling is to be set up for periodic transmission of particular uplink control information. In alternative implementations, instead of periodic transmission of particular uplink control information, the semi-persistent scheduling can specify repeated transmission of the particular uplink control information, where the repeated transmission can be intermittent transmissions.

Once semi-persistent scheduling is set up at the mobile station 110, the mobile station 110 is able to transmit the particular uplink control information repeatedly (e.g., periodically) on the PUSCH, as indicated by 208, 210 in FIG. 2.

Note that although the particular uplink control information is depicted as being transmitted on PUSCH in FIG. 2, it is also contemplated that PUCCH can also be used to transmit at least some of the particular uplink control information, in addition to using PUSCH.

By using semi-persistent scheduled transmission according to some embodiments to allow for periodic transmission of the particular control information, the base station 100 does not have to provide a specific grant for each transmission of the particular uplink control information on the PUSCH. This reduces overhead in the wireless link.

Moreover, the particular control information can be sent on the PUSCH even if there is no uplink bearer traffic to send on the PUSCH. In addition, the periodic transmission of the particular uplink control information on PUSCH can occur without a specific request by the mobile station for each such transmission on PUSCH.

The semi-persistent scheduled periodic transmission of particular uplink control information can be terminated when a new uplink grant is sent by the base station to the mobile station, in response to a scheduling request for uplink traffic data transmission by the mobile station, or in response to some other control message from the base station 100.

In accordance with specific embodiments, the downlink control message can be a downlink control information (DCI) of format 0 according to the EUTRA standard, as defined by TS 36.212. In specific examples, semi-persistent scheduling for the periodic transmission of particular uplink control information is requested in response to the mobile station receiving a DCI according to format 0 with a CRC scrambled by the SPS-RNTI, and with the DCI format 0 having the following fields set according to the following example values below:

I_{MCS}=29;

“CQI request”=1; and

N_{PRB}≦4.

The I_{MCS} field is a modulation and coding scheme and redundancy version field. The “CQI request” field being set to one indicates that CQI reporting is requested. The N_{PRB} field refers to the total number of allocated physical resource blocks.

Note that the foregoing combination is provided for purposes of example, as other implementations can use other fields or other field values for fields in the DCI. In other implementations, other formats of DCI can be used to indicate semi-persistent scheduling of transmission of particular uplink control information.

The semi-persistent scheduling can be configured with a particular periodicity, such as transmission of the particular control information every N frames, where N≧2. It is desired that N be set to a value that allows for sufficient opportunity for HARQ-ACK feedback and/or desired CQI/PMI/RI reporting in some examples. Note that HARQ-ACK is sent over PUCCH in sub-frame T+4 for a downlink packet received in sub-frame T, unless there is a PUSCH to be sent in sub-frame T+4.

Machine-readable instructions described above (including instructions of the software 126 and 134 of FIG. 1) are loaded for execution on at least one processor (e.g., CPU(s) in FIG. 1). A processor can include a microprocessor, microcontroller, processor module or subsystem, programmable integrated circuit, programmable gate array, or another control or computing device.

Data and instructions are stored in respective storage devices, which are implemented as one or plural computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. “Storage media” is intended to either a singular storage medium or plural storage media. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1.-22. (canceled)

23. A method comprising:
receiving, by a long term evolution (LTE) mobile station, a downlink control message associated with an indication that particular control information is to be transmitted by the LTE mobile station on an uplink traffic channel on a repeated basis; and
transmitting the particular control information on the uplink traffic channel to a long term evolution enhanced node B on a repeated basis.

24. The method of claim 23, wherein transmitting the particular control information on the repeated basis comprises transmitting the particular control information periodically using a physical uplink shared channel.

25. The method of claim 24, wherein transmitting the particular control information on the periodic basis is performed as part of semi-persistent scheduling, wherein the repeated transmissions of the particular control information uses one or more of the same transport block size, modulation and coding scheme, and channel resources.

26. The method of claim 23, wherein receiving the downlink control message associated with the indication comprises receiving the downlink control message having a portion scrambled with the indication.

27. The method of claim 26, wherein receiving the downlink control message having the portion scrambled within the indication comprises receiving the downlink control message having the portion scrambled with a semi-persistent scheduling radio network temporary identifier.

28. The method of claim 27, further comprising decoding the downlink control message with the scrambled portion to detect that the semi-persistent scheduling is to be set up at the mobile station.

29. The method of claim 23, wherein transmitting the particular control information comprises transmitting one or more of a rank indicator, a channel quality indicator, a precoding matrix indicator, or a hybrid automatic repeat request (HARQ) acknowledgment.

30. The method of claim 23, wherein receiving the downlink control message comprises receiving downlink control information according to Evolved Universal Terrestrial Radio Access (EUTRA) DCI format 0.

31. A method comprising:
sending, by a long term evolution enhanced node B, a downlink control message associated with an indication that particular control information is to be transmitted by a mobile station on an uplink traffic channel on a repeated basis; and
receiving, by the base station, the particular control information on the uplink traffic channel on the repeated basis.

32. The method of claim 31, wherein receiving the particular control information on the repeated basis comprises transmitting the particular control information periodically according to semi-persistent scheduling.

33. The method of claim 31, wherein sending the downlink control message associated with the indication comprises receiving the downlink control message having a portion scrambled with the indication.

34. The method of claim 33, wherein sending the downlink control message having the portion scrambled within the indication comprises receiving the downlink control message having the portion scrambled with a semi-persistent scheduling radio network temporary identifier.

35. The method of claim 31, wherein receiving the particular control information comprises receiving one or more of a rank indicator, a channel quality indicator, a precoding matrix indicator, or a hybrid automatic repeat request (HARQ) acknowledgment.

36. A long term evolution (LTE) mobile station configured to:
receive a downlink control message associated with an indication that particular control information is to be transmitted by the mobile station on an uplink traffic channel on a repeated basis; and
transmit the particular control information on the uplink traffic channel to a long term evolution enhanced node B on a repeated basis.

37. The mobile station of claim 36, wherein the particular control information is transmitted on a periodic basis as part of semi-persistent scheduling.

38. The mobile station of claim 36, wherein the downlink control message has a portion scrambled with the indication.

39. The mobile station of claim 38, wherein the indication comprises a semi-persistent scheduling radio network temporary identifier.

40. The mobile station of claim 36, wherein the particular control information comprises one or more of a rank indicator, a channel quality indicator, a precoding matrix indicator, or a hybrid automatic repeat request (HARQ) acknowledgment.

41. A long term evolution enhanced node B (eNB) comprising:
an interface to a wireless link; and
at least one processor configured to:
send a downlink control message associated with an indication that particular control information is to be transmitted by a mobile station on an uplink traffic channel on a repeated basis; and
receive the particular control information on the uplink traffic channel on a repeated basis, wherein the particular control information is transmitted by the mobile station in response to the downlink control message associated with the indication.

42. The eNB of claim 41, wherein the downlink control message has a portion scrambled with the indication.

43. The eNB of claim 41, wherein the particular control information comprises one or more of a rank indicator, a channel quality indicator, a precoding matrix indicator, or a hybrid automatic repeat request (HARQ) acknowledgment.
